(19) United States
(12) Patent Application Publication
(10) Pub. No.: US 2004/0101278 A1
(43) Pub. Date: May 27, 2004

(54) Recording apparatus capable of recording information representing positions on a recording medium and recording method

(75) Inventors: Jiro Moriyama, Kanagawa (JP); Hidehiko Kanda, Kanagawa (JP)

Correspondence Address: Canon U.S.A. Inc., Intellectual Property Department, 15975 Alton Parkway, Irvine, CA, 92618-3731, US

(73) Assignee: Canon Kabushiki Kaisha, Ohta-ku (JP)

(21) Appl. No.: 10/715,957

(22) Filed: Nov. 17, 2003

(30) Foreign Application Priority Data
Nov. 19, 2002 (JP) 2002/335769

(51) Int. Cl. H04N 5/76; H04N 5/781

(52) U.S. Cl. 386/46; 386/126

(57) ABSTRACT

A recording apparatus capable of recording images and positional information representing positions on a recording medium on the recording medium. Positional information is read by detecting an image recorded with a predetermined recording material or by using a device capable of reading the information. The positional information is recorded with a recording material capable of being detected by a device and an image other than the positional information is recorded with another recording material.

### BACKGROUND OF THE INVENTION

1. Field of the Invention

The present invention relates to a recording apparatus capable of recording at least one of positional information image corresponding to its own recording position and the other image by applying a recording material to the recording medium.

2. Description of the Related Art

Recording apparatuses have been generally known which use a plurality of color inks including cyan (C), magenta (M) and yellow (Y), and further black (Bk).

On the other hand, as a recording medium capable of handwriting thereon, a type has been known over which positional information has been previously printed. This positional information includes information designating the position where the positional information is recorded on the recording medium, that is, information whose recording position is associated with coordinates on the recording medium. The positional information is, for example, expressed by a combination pattern of a plurality of black spots recorded on the recording area.

For handwriting characters and the like on such a recording medium including positional information recorded thereon, a pen integrated with a miniature camera capable of detecting and recording images is used. The camera detects the black spot pattern on the recording medium at the vicinity of the pen point. Thus, the character position and the characters, which is on the locus of pen movement, are recognized from the pattern. The recognition of the handwritten characters and the like may be carried out by an information processor, such as a personal computer, to which the signal detected by the camera is transmitted by, for example, radio communication. This technique for inputting handwritten characters and the like with a pen is hereinafter referred to as “pen input method” in some cases.

However, since the above-described positional information has previously been printed on a recording medium, users must purchase, for example, recording medium with the positional information printed thereover. Consequently, positional information cannot be arbitrarily recorded on the recording medium. For example, the shape, size, relative position and so on of the region identifying a handwriting position cannot be flexibly set. Furthermore, if an image is recorded on a recording medium with the positional information printed thereon using a recording apparatus, the image prevents the positional information from being read. Thus the positional information may not function undesirably. Users cannot record an arbitrary image on a recording medium with the positional information printed thereon using a recording apparatus.

### SUMMARY OF THE INVENTION

Accordingly, an object of the present invention is to provide a recording apparatus capable of arbitrarily recording positional information and images.

In the present invention, a recording apparatus for performing recording by applying a recording material onto a recording medium records an image representing positional information of positions on the recording medium and the other image. The positional information image is recorded with a recording material different from that of the other image.

According to an aspect of the present invention, a recording apparatus for forming an image on a recording medium by applying a recording material onto a recording medium is provided. In the recording apparatus, at least one of a positional information image representing positional information corresponding to the position where the positional information image is recorded and the other image are recorded. The positional information image is recorded with a recording material capable of being detected by a predetermined detector, and the other image is recorded with another recording material incapable of being detected by the detector.

Further objects, features and advantages of the present invention will become apparent from the following description of the preferred embodiments with reference to the attached drawings.

### BRIEF DESCRIPTION OF THE DRAWINGS

FIG. 1 is a perspective view of a principal part of an ink jet recording apparatus of the present invention.

FIG. 2 is a block diagram of a recording apparatus according to a first embodiment of the present invention.

FIG. 3 is a block diagram of a host device shown in FIG. 2.

FIG. 4 is a representation of a positional information image according to a first embodiment of the present invention.

FIGS. 5 and 6 are flow charts of image processing according to an embodiment of the present invention.

### DESCRIPTION OF THE PREFERRED EMBODIMENTS

Preferred embodiments of the present invention will now be described with reference to the drawings.

First Embodiment

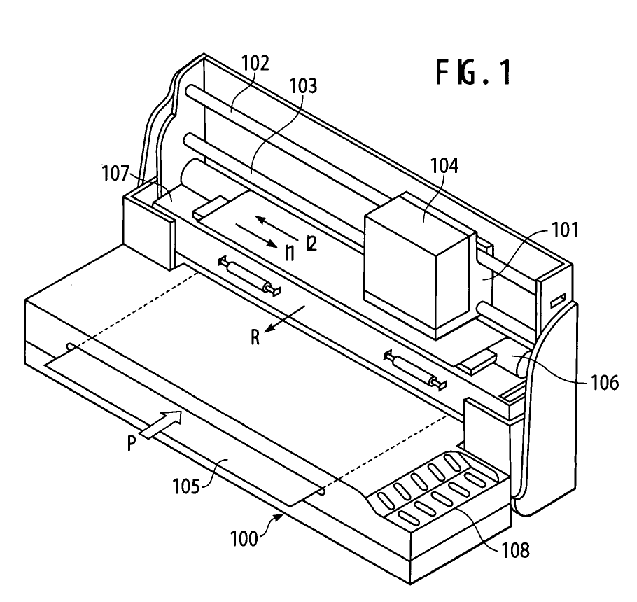

In the first embodiment, the present invention will be described using an ink jet recording apparatus, which discharges ink onto a recording medium. FIG. 1 shows the structure of the ink jet recording apparatus of the present invention.

A recording medium 105 is fed in the direction designated by arrow P from a feeding position in the front of an ink jet recording apparatus (printer, in the first embodiment) 100. The feed direction of the recording medium 105 is reversed at the back of the recording apparatus 100, and the recording medium 105 is delivered in a secondary scanning direction, designated by arrow R, to a recordable area of a recording head 104, by a delivery roller 106. Under the recording medium 105 in the recordable area, a platen 107 is disposed. A carriage 101 shifts in primary scanning directions, designated by arrows 11 and 12, along guide axes 102 and 103, and thus reciprocally scans the scan area including the recordable area by driving a stepping motor, not shown in the figure. The carriage 101 holds the recording head 104 capable of discharging ink from discharge holes. After the recording head 104 has finished one primary scan, the recording medium 105 is delivered a predetermined distance in the secondary scanning direction R and prepares for the next primary scan. By repeating the primary scan and secondary scan, an image is recorded on a sheet of the recording medium 105.

The recording head 104 is detachably or integrally combined with an ink reservoir (not shown) containing ink to constitute an ink jet cartridge. The recording head 104 records an image on the recording medium 105 by discharging the ink supplied from the ink reservoir from discharge holes in the downward direction of the figure. Reference numeral 108 designates a portion where switches and a display portion are disposed. A switch portion is used for switching power on/off, recording modes, and the like. The display portion is structured so as to display the state of the recording apparatus.

The recording head 104 can discharge inks of four colors: Y (yellow), M (magenta), C (cyan), and Bk (black). The Y, M, C inks are each discharged from 128 discharge holes, and the Bk ink is discharged from 320 discharge holes. The discharge holes of each color ink are aligned in the secondary scanning direction with a pitch of about 42 μm, equivalent to 1/600 dpi (dots per inch). The recording head 104 includes a heater (not shown) that is an electro-thermal converter for each discharge hole. The heater generates thermal energy to bubble ink so that the ink is discharged by bubble pressure. The recording head 104 operates at a frequency of 15 kHz and it can record at a density of 600 dpi in the primary scanning direction. Hence, the shifting speed in the primary scanning direction of the carriage 101 is 25 in/s (inches per second).

The Bk ink comprises a pigment containing carbon black as the coloring material (hereinafter referred to as carbon Bk ink in some cases), and the Y, M, and C inks each comprise a dye as the coloring material (hereinafter referred to as dye ink in some cases), as described later. In the ink jet recording apparatus of the present embodiment, the discharge quantity of the carbon Bk ink is set at about 30 pL (picoliter), and the discharge quantities of the Y, M, C dye inks are each set at about 5 pL. Discharge operation is controlled so that these quantities of the inks are discharged for each dot. The following description is on the precondition that the recording apparatus has a recording resolution of 600×600 dpi and uses a common recording medium referred to as plain paper. A droplet of the Bk ink discharged from the recording head 104 forms one dot in a 1/600-inch square recording area, and droplets of the Y, M, and C color inks form two dots in a 1/600-inch square recording area. These values are varied according to the characteristics of the recording medium 105, even when only plain paper is used. The recording apparatus of the present embodiment is designed according to the characteristics of generally available, widely used recording medium.

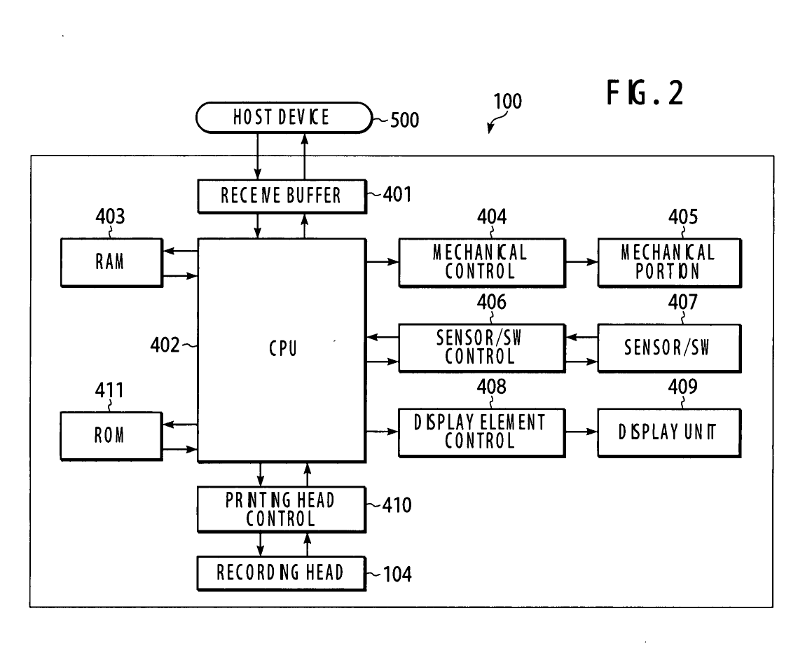

FIG. 2 is a block diagram showing the main part configuration involved in control of the above-described ink jet recording apparatus. Record data of characters and images to be recorded is transmitted to the recording apparatus 100 from a host device 500, and the data is stored in a receive buffer 401. The recording apparatus 100 transmits data for checking whether data is correctly transmitted and for informing of its own operative state to the host device 500. The host device 500 may be a personal computer (PC) or a digital camera that can transmit data to the recording apparatus 100.

The data stored in the receive buffer 401 is processed into data for recording under the control of the CPU 402 while the recording head 104 is scanning in the primary scanning direction, and subsequently stored in a print buffer in a random access memory (RAM) 403. The data in the print buffer is transferred to the recording head 104 by a printing head control 410. The recording head 104 is driven according to the data, thereby discharging the color inks to record images including characters. The printing head control 410 also detects information representing the state of the recording head 104, such as temperature; transmits the information to a CPU 402; and controls the operation of the recording head 104 according to the information.

A mechanical control 404 controls the operation of a mechanical portion 405 including, for example, a carriage motor for shifting the carriage 101 and a line feed motor for delivering the recording medium 105, according to instruction from the CPU 402. A sensor/SW control 406 transmits signals from a sensor/SW portion 407 including various sensors and switches to the CPU 402. A display element control 408 controls a display unit 409 including LEDs or liquid crystal display elements of display panels according to instruction from the CPU 402.

The recording apparatus 100 selects a recording mode from a plurality of recording modes according to the selection input by a user and records images in the selected recording mode. For example, if high-speed recording is desired, a one-pass recording mode is selected; if high-quality recording is desired, a 16-pass recording mode is selected. In the one-pass recording mode, the recording head 104 records an image by scanning once for an identical recording area; in the 16-pass recording mode, the recording head 104 records an image by scanning in the primary scanning direction 16 times for an identical recording area while shifting (that is, delivering the recording medium) in the secondary direction in predetermined distances.

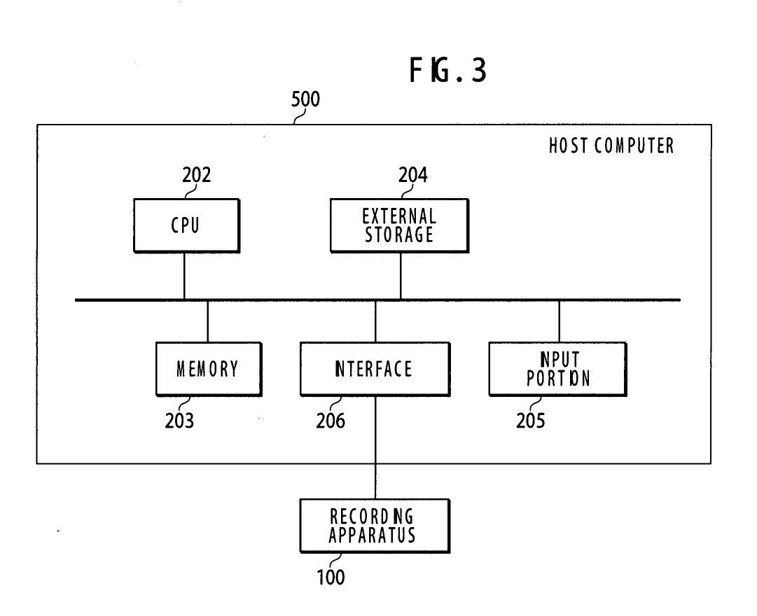

FIG. 3 is a block diagram showing the configuration of the host computer 500 serving as the host device shown in FIG. 2. The host computer 500 and the recording apparatus 100 described with reference to FIG. 2 constitute a recording system.

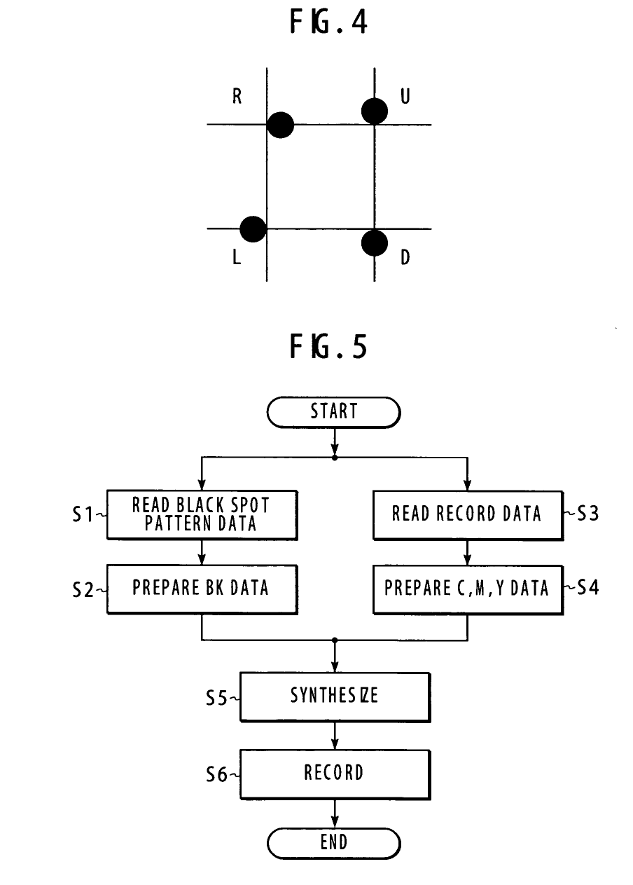

The host computer 500 includes a CPU 202, a memory 203, an external storage 204, an input portion 205, and an interface 206 between the host computer 500 and the recording apparatus 100. The CPU 202 performs various types of processing according to programs stored in the memory 203. For example, processing for preparing and editing an image including characters is performed according to a user input from the input portion 205. For recording such an image, image processing such as color conversion is performed by a printer driver, which is one of the programs, to prepare data used in the recording apparatus 100. Specifically, R, G, and B data of the prepared and edited image are subjected to predetermined image processing, such as color conversion, output γ correction, and quantization (binarization), to yield C, M, and Y binary data. In this data processing, binary data for the carbon Bk ink for recording a black spot pattern, described later with reference to FIG. 4, is obtained. The host computer 500, which is connected to the recording apparatus 100 through the interface 206, transmits recording data obtained by the image processing to the recording apparatus 100 to perform recording.

The programs may be stored in the external storage 204 or supplied from an external device.

FIG. 4 is a representation of an example of positional information used in the pen input method. In the present embodiment, such a pattern image representing positional information is recorded by the recording apparatus 100. Specifically, a positional information image is recorded on a recording medium with the carbon Bk ink, and ordinary images other than the positional information image (hereinafter referred to as other images in some cases) are recorded with C, M, and Y inks.

The positional information is recorded in a predetermined pattern form of black spots dotted, for example, over the entire recordable area, on the recording medium 105. Specifically, the black spots are recorded on the recording medium 105 with reference to assumed lattice points arranged at predetermined intervals. For example, a black spot is provided at the vicinity of each of lattice points arranged at intervals of about 0.3 mm. As shown in FIG. 4, there are four recording positions consisting of position U above a lattice point, position D below the lattice point, position R at the right of the lattice point, and position L at the left of the lattice point for each black spot. A positional pattern formed with a predetermined plurality of the black spots constitute “positional information”. For example, a pattern of black spots recorded at the vicinities of the respective lattice points in a predetermined two-dimensional arrangement defining a unit region is varied from one unit region to another. Thus, the positional pattern, that is, a combination of above-described positions U, D, R, and L represents the “positional information” of the unit region. As described above, by detecting the black spot pattern with a camera at the end of a pen and reading the positional pattern as positional information for each unit region, the position on a recording medium where the pen point is placed can be known, or it can be made sure that the position where the pen point is placed is in a predetermined region on the recording medium.

In addition, the number of combinations of positions U, D, R, and L allows the positional information to represent a position in a vast virtual plane far beyond the area of a recording medium. For example, if the same positional pattern is not used twice or more for recording media, a positional pattern can identify a recording medium with the positional pattern recorded thereon by establishing correspondences between the positional patterns and the recording media.

If characters or the like are handwritten on a recording medium 105 with such positional information thereon, a pen integrated with a miniature camera (pen camera) may be used. The camera shoots the vicinity of the pen point, thereby reading positional information expressed by the black spots on the recording medium. The positional information helps the pen read images including handwritten characters. Specifically, the positional information indicates the locus of pen movement, thus helping the recognition of the handwritten characters and the like. An information processor to which the signal detected by the camera is input may carry out the recognition of the handwritten characters and the like.

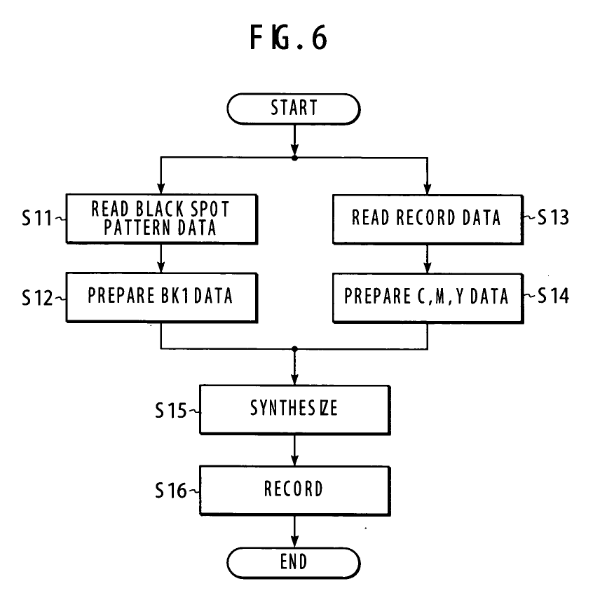

In the present invention, in order for the camera to detect the black spot pattern, the pattern is recorded with the carbon Bk ink, and the camera has a structure capable of detecting carbon in the ink on the recording medium 105. The ordinary image other than the black spot pattern is recorded with the Y, M, and C dye inks not containing carbon. Hence, the camera does not detect these dye inks or the image formed with these inks. FIG. 5 is a flow chart of a procedure in which the recording apparatus 100 simultaneously records a positional information image based on the black spot pattern and ordinary images based on record data of images other than the positional information image. In the recording apparatus 100, the recording head for the Bk ink is intended for use of a Bk ink containing carbon, and the recording heads for the Y, M, and C inks respectively discharge the Y, M, and C inks not containing carbon.

First, a user selects an ordinary image including characters that they want to record and presses a record button to start process using a personal computer (PC) being the host device 500 of the recording apparatus 100. Two types of process are performed in Steps S1 and S2 for recording a positional information image and Steps S3 and S4 for recording the other image.

Black pattern data for recording the positional information image is read in Step S1, and Bk record data for recording the positional information image with the recording head for discharging the Bk ink is prepared in Step S2. On the other hand, record data for recording a desired image including characters is read in Step S3, and Y, M, and C record data for recording an ordinary image with the recording heads for discharging the Y, M, and C inks are prepared in Step S4. Black color in the ordinary image is recorded with the Y, M, and C inks. Thus, the ordinary color image including black is recorded according to the Y, M, and C record data.

The Bk record data and the Y, M, and C record data are synthesized in Step S5. This synthesis is simply performed by transmitting the Y, M, C, and Bk record data to respective print buffers, as in a conventional recording system.

Then, positional information and an image are recorded according to the Y, M, C, and Bk record data in the print buffers in Step S6. Specifically, the positional information is recorded with the Bk ink containing carbon according to the Bk record data, and the image is recorded with the carbon-free Y, M, and C inks according to the Y, M, and C record data.

The positional information recorded on the recording medium 105 together with the image can be detected by a carbon sensor without confusing with the image. Hence, by reading positions on the locus of movement of the pen point with a pen integrated with a miniature camera capable of detecting carbon, as described above, handwritten characters and the like can be recognized.

For the pen input method, by recording a positional information image over the entire area of a recording medium 105, handwritten characters and the like in the entire area of the recording medium can be recognized. The positional information may be recorded only in the portions of the recording medium 105 where characters and the like to be recorded. Thus, the recording area of the positional information can be set according to use. In any case, the positional information is associated with the position where the information is to be recorded, that is, associated with coordinates on the recording medium 105. Since the positional information image is detected without confusing with the ordinary image, the ordinary image can be arbitrarily recorded, for example, so as to overlap or cover the positional information image.

Steps S1 to S5 shown in FIG. 5 may be performed by the host device 500 or the recording apparatus 100. Steps S1 to S4 may be performed in the host device 500 and the recording apparatus 100 separately. For example, Steps S1, S2, and S5 may be performed in the recording apparatus 100, and Steps S3 and S4 in the host device 500; or Steps S1 and S2 may be performed in the recording apparatus 100, and Steps S3, S4, and S5 in the host device 500. In the latter case, the Bk record data prepared in Step S2 is transmitted to the host device 500.

Second Embodiment

In the first embodiment, the Bk ink containing carbon and the Y, M, and C inks not containing carbon are used, but inks are not limited to these. For example, a higher quality image can be recorded by use of a carbon-free Bk ink.

FIG. 6 is a flow chart of a procedure in which a carbon-free Bk ink is used. The second embodiment involves use of two types of Bk ink-discharge recording heads: one is for discharging a Bk1 ink containing carbon and the other is for discharging a Bk2 ink not containing carbon. The carbon-free Y, M, and C inks are discharged from other recording heads. As in the first embodiment, a positional information image according to black spot pattern data and the other image according to ordinary image record data are recorded at one time.

Black spot pattern data for recording the positional information image is read in Step S11, and Bk1 record data for recording the positional information image with the Bk1 ink-discharge recording head is prepared in Step S12. On the other hand, record data for recording a desired image is read in Step S13, and Y, M, C, and Bk2 record data for recording the ordinary image with the recording heads for discharging the Y, M, C, and Bk2 inks are prepared in Step S14. Black color in the ordinary image is recorded with the Bk2 ink. Thus, the ordinary color image is recorded according to the Y, M, C, and Bk2 record data.

The Bk1 record data and the Y, M, C, and Bk2 record data are synthesized in Step S15. This synthesis is simply performed by transmitting the Y, M, C, and Bk record data to respective print buffers, as in a conventional recording system.

Then, a positional information image and the other ordinary image are recorded according to the Y, M, C, Bk1, and Bk2 record data in the print buffers in Step S16. Specifically, the positional information image is recorded with the carbon-containing Bk1 ink according to the Bk1 record data, and the ordinary image is recorded with the carbon-free Y, M, C, and Bk2 inks according to the Y, M, C, and Bk2 record data. The discharge quantity of the Bk2 ink is set to be equal to that of the Y, M, and C inks (for example, at 5 pL).

Preparation of Inks

Examples of preparing inks used in the present invention will now be described.

(1) Carbon-Containing Black Ink (Bk or Bk1 Ink)

The following ingredients are mixed and sufficiently stirred. Then, the mixture is filtered through a microfilter with a pore size of 3.0 μm (produced by Fuji Photo Film Co., Ltd.) under an increased pressure to prepare the black ink.

| | | |
|---|---|---|
| disperse pigment described below: | 30 | parts |
| ammonium benzoate: | 1 | part |
| trimethylolpropane: | 6 | parts |
| glycerin: | 5 | parts |
| diethylene glycol: | 5 | parts |
| ethylene oxide adduct of acetylene glycol | 0.15 | part |
| (Product name: Acetylenol EH): | | |
| water: | 52.85 | parts |

Disperse Pigment

After 10 g of carbon black having a specific surface area of 260 m²/g and a DBP absorption of 115 mL/100 g and a 2.5 g of p-aminobenzoic acid are mixed with 72 g of water, 1.62 g of nitric acid is added to the mixture, followed by stirring at 70° C. After a few minutes, a solution containing 1.07 g of sodium nitrite dissolved in 5 g of water is added to the mixture, followed by stirring for another one hour. The resulting slurry is filtered through a Toyo Roshi No. 2 filter paper (produced by Advantis K.K.). The collected pigment particles are thoroughly washed with water and are dried in an oven at 90° C. Water is added to the pigment to yield a disperse pigment containing 10 percent by weight of the pigment. Thus, a group expressed by the following formula is introduced to the surfaces of the carbon black.

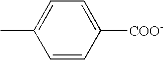

(2) Dye Inks (Y, M, C, and Bk Inks)

Y (Yellow Ink)

The following ingredients are mixed and sufficiently stirred. Then, the mixture is filtered through a microfilter with a pore size of 0.2 μm (produced by Fuji Photo Film Co., Ltd.) under an increased pressure to prepare the yellow ink.

| | | |
|---|---|---|
| ethylene oxide adduct of acetylene glycol | 1 | part |
| (Product name: Acetylenol EH): | | |
| diethylene glycol: | 10 | parts |
| glycerin: | 5 | parts |
| CI Direct Yellow 86: | 3 | parts |
| water: | 81 | parts |

M (Magenta Ink)

The following ingredients are mixed and sufficiently stirred. Then, the mixture is filtered through a microfilter with a pore size of 0.2 μm (produced by Fuji Photo Film Co., Ltd.) under an increased pressure to prepare the magenta ink.

| | | |
|---|---|---|
| ethylene oxide adduct of acetylene glycol | 1 | part |
| (Product name: Acetylenol EH): | | |
| diethylene glycol: | 10 | parts |
| glycerin: | 5 | parts |
| CI Acid Red 35: | 3 | parts |
| water: | 81 | parts |

C (Cyan Ink)

The following ingredients are mixed and sufficiently stirred. Then, the mixture is filtered through a microfilter with a pore size of 0.2 μm (produced by Fuji Photo Film Co., Ltd.) under an increased pressure to prepare the cyan ink.

| | | |
|---|---|---|
| ethylene oxide adduct of acetylene glycol | 1 | part |
| (Product name: Acetylenol EH): | | |
| diethylene glycol: | 10 | parts |
| glycerin: | 5 | parts |
| C.I. Acid Blue 9: | 3 | parts |
| water: | 81 | parts |

Bk2 (Black Ink)

The following ingredients are mixed and sufficiently stirred. Then, the mixture is filtered through a microfilter with a pore size of 0.2 μm (produced by Fuji Photo Film Co., Ltd.) under an increased pressure to prepare the black ink.

| | | |
|---|---|---|
| ethylene oxide adduct of acetylene glycol | 1 | part |
| (Product name: Acetylenol EH): | | |
| diethylene glycol: | 10 | parts |
| glycerin: | 5 | parts |
| CI Food Black 2: | 3 | parts |
| water: | 81 | parts |

Modifications

As described above, for reading positional information with a sensor, such as a carbon-detectable camera, the types and colors of ingredients of the recording material, such as ink or toner, are not particularly limited, as long as the positional information image is recorded with a recording material containing carbon and the other image is recorded with carbon-free recording materials. For example, the carbon-containing recording material may be a Bk pigment ink, and the carbon-free recording materials may be dye or pigment inks. In addition to use of both pigment ink and dye ink, a mixture of these inks may be used.

The present invention may be applied to various types of recording apparatus in which recording is performed by applying a recording material onto a recording medium, in addition to the ink jet recording apparatus using record heads capable of discharging inks.

In the above-described embodiments, only one recording apparatus records the positional information image and the other image at one time. However, one or more of recording apparatuses may record the positional information image and the other image separately. For example, a predetermined recording apparatus may record only the positional information image to prepare a recording medium containing positional information, and the same recording apparatus or another recording apparatus may record the other image on the recording medium containing positional information. Furthermore, the information image or the other image may be recorded at several times with one or more of recording apparatuses. The upshot is that the recording material of the positional information image is varied from that of the other image so as to detect the positional information image without confusing with the other image.

The positional information recorded on a recording medium is not only used in the pen input method, but also used as data for various types of information processing with positional information detected by a sensor. The record pattern of the positional information is not limited to the above-described dot pattern, and any pattern may be used.

The positional information is recorded with the carbon-containing Bk ink according to the pen input method using a carbon-detectable camera integrated with a pen, in the foregoing embodiments. However, the recording material for the positional information is not limited to the carbon-containing Bk ink, and any recording material may be used as long as a pen camera can detect the material. For example, ink containing a fluorescent dye may be used instead of the carbon-containing Bk ink. In this instance, diaminostilbenesulfonic acid derivatives can be used because diaminostilbenes exhibit fluorescent characteristics. For the pen camera, a high-sensitive sensor capable of detecting ultraviolet wavelength or a filter may be used. In this instance, by recording the positional information with a bright color material, quality degradation of images including characters can be prevented. In view of image quality, the positional information recorded with the carbon-containing Bk ink may negatively affect the quality of images to be recorded including characters to some extent because the positional information is reflected as particles in human eyes, even though it is expressed by miniature dots (black spots).

As described above, the present invention may be applied to a system including a plurality of apparatuses, such as a host computer, an interface device, a reader, and a printer, or a single apparatus, such as a copier or a fax machine.

In the present invention, the functions of the embodiments may be realized by an apparatus or system including various devices and a computer (CPU or MPU) connected with the devices. In this apparatus or system, program codes of software for realizing the functions are supplied to the computer, and the devices are operated according to a program stored in the computer.

In this instance, the program codes of the software realize the functions. The program codes and means for supplying the codes to the computer, for example, a recording medium containing the program codes, are in part of the present invention.

As described above, when at least one of positional information image corresponding to its one recording position and the other image is recorded, the present invention makes it possible to detect the positional information image without confusing it with the other image by varying the recording materials between the positional information image and the other image. Thus, users can arbitrarily record positional information and images without interference with the detection of the positional information.

In particular, the positional information is associated with its own recording position, and the positional information is recorded on a recording medium is logically determined according to the information. Therefore, the recording position of the positional information cannot be arbitrarily set, for example, so as not to overlap with the recording position of the other image. According to the present invention, the positional information image having such a limit as to the recording position and the other image are arbitrarily recorded.

Recording media with positional information recorded thereon can be used in, for example, the pen input method. Users can prepare such a recording medium if necessary. The positional information can be arbitrarily recorded on the recording medium. For example, the shape, size, relative position of the region identifying a handwriting position can be flexibly set. Furthermore, since users prepare a recording medium with the positional information recorded thereon as needed, it is not necessary for the users to purchase and store a recording medium on which positional information has been previously recorded.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A recording apparatus for forming an image on a recording medium, comprising:
recording means for performing recording by applying a recording material onto the recording medium, the recording means recording at least one of a positional information image representing positional information corresponding to the position where the positional information image is recorded and the other image; and
a control means for controlling the recording such that the recording means records the positional information image with a recording material capable of being detected by a predetermined detector, and said other image with another recording material incapable of being detected by the detector.

2. A recording apparatus according to claim 1, wherein the recording material used for recording the positional information image contains carbon, and the recording material used for recording said other image is carbon-free.

3. A recording apparatus according to claim 1, wherein the recording material used for recording the positional information image comprises one of a pigment ink containing carbon and a dye ink containing carbon, and the recording material used for recording said other image comprises one of a carbon-free pigment ink and a carbon-free dye ink.

4. A recording apparatus according to claim 1, wherein the recording material for the positional information image is black, and the recording material for said other image is a plurality of recording materials capable of recording a color image.

5. A recording apparatus according to claim 4, wherein the plurality of recording materials correspond to a plurality of colors including yellow, magenta, and cyan.

6. A recording apparatus according to claim 4, wherein the plurality of recording materials have a plurality of colors including yellow, magenta, cyan, and black.

7. A recording apparatus according to claim 1, wherein the positional information image is expressed by a combination pattern of a plurality of spots to represent the positional information.

8. A recording apparatus according to claim 1, wherein the positional information is associated with coordinates on the recording medium.

9. A recording apparatus according to claim 1, wherein the positional information is associated with coordinates on a virtual plane beyond the area of the recording medium.

10. A method for recording an image with a recording apparatus that applies a recording material onto a recording medium, the method comprising:
the recording step of recording at least one of a positional information image corresponding to positional information representing at least positions on the recording medium and the other image, on the recording medium; and
the control step of controlling the recording step such that the positional information image is recorded with a recording material capable of being detected by a predetermined detector, and said the other image is recorded with another recording material incapable of being detected by the detector.

11. A recording medium including:
a pattern image designating positions at least thereon, the pattern image being recorded by applying a first recording material capable of being detected by a predetermined detector; and
the other image recorded by applying a second recording material incapable of being detected by the detector.

12. A recording system comprising:
a recording apparatus for performing recording by applying a recording material onto a recording medium according to image data, the recording apparatus recording positional information representing positions on at least the recording medium and the other image, the recording apparatus including control means for controlling recording such that the positional information is recorded with a recording material capable of being detected by a predetermined detector, and said the other image is recorded with a recording material incapable of being detected by the detector; and
a transmitting apparatus for transmitting the image data to the recording apparatus, the transmitting apparatus including image data preparation means and image data transmission means.

13. A program for controlling a recording apparatus for recording an image by applying a recording material onto a recording medium, the program performing:
the recording step of recording an positional information image corresponding to positional information representing positions on at least the recording medium and the other image, on the recording medium;
the control step of controlling the recording step such that the positional information image is recorded with a recording material capable of being detected by a predetermined detector, and said the other image is recorded with another recording material incapable of being detected by the detector.
